(19) United States
(12) Patent Application Publication
(10) Pub. No.: US 2023/0151863 A1
(43) Pub. Date: May 18, 2023

(54) ACTUATOR ASSEMBLY FOR A VEHICLE BRAKE AND ELECTROMECHANICAL VEHICLE BRAKE

(71) Applicant: ZF Active Safety GmbH, Koblenz (DE)

(72) Inventors: Volker Knop, Ulmen (DE); Nicholas Alford, Waldesch (DE); Werner Seibert, Kammerforst (DE); Christoph Beuerle, Koblenz (DE); Markus Mallmann, Pfalzfeld (DE)

(21) Appl. No.: 17/988,466

(22) Filed: Nov. 16, 2022

(30) Foreign Application Priority Data
Nov. 17, 2021 (DE) 102021129969.1

(51) Int. Cl. F16D 65/18

(52) U.S. Cl. CPC F16D 65/18; F16D 2121/24

(57) ABSTRACT

An actuator assembly for an electromechanical vehicle brake is disclosed, having a carrier assembly with a frame part, and a guide part in which an actuating slide for a brake pad is mounted so as to be linearly displaceable. The guide part has a rotational locking geometry by which the guide part is rotationally fixedly received in the frame part by form fit. An electromechanical brake is also proposed.

### CROSS-REFERENCE TO RELATED APPLICATION

This application claims priority to German Priority Application No. 102021129969.1, filed Nov. 17, 2021, the disclosure of which is incorporated herein by reference in its entirety.

### TECHNICAL FIELD

The disclosure concerns an actuator assembly for an electromechanical vehicle brake with a carrier assembly having a frame part, and a guide part which is received in the frame part and in which an actuating slide for a brake pad is mounted so as to be linearly displaceable. The disclosure also concerns an electromechanical brake.

### BACKGROUND

An actuating slide of a brake may be moved optionally between a retracted position and an extended position, and serves to apply a brake pad to a brake disc.

Usually, for linear guidance of the actuating slide, a guide part is provided in which the actuating slide is received and linearly guided.

In order to guarantee a reliable force transmission to the actuating slide, ‘the connection between the frame part and the guide part must be made as stiff as possible.

### SUMMARY

What is needed is a connection between a frame part and a guide part of an actuator assembly which is sufficiently stiff for a reliable force transmission and also easy to produce.

An actuator assembly for a vehicle brake is disclosed herein, with a carrier assembly having a frame part, and a guide part in which an actuating slide for a brake pad is mounted so as to be linearly displaceable, wherein the guide part has a rotational locking geometry by which the guide part is rotationally fixedly received in the frame part by form fit.

The actuator assembly according to the disclosure has the advantage that the connection between the frame part and the guide part is particularly stiff. This guarantees a stable guidance of the actuating slide and a reliable force transmission to the actuating slide. For example, it avoids a relative movement between the frame part and the guide part, such as a rotational or tilting movement.

The form-fit, rotationally fixed connection is preferably a shaft-hub connection, for example a splined shaft connection. A shaft-hub connection is easy to produce and allows a form-fit connection in a simple and reliable fashion. A splined shaft connection also achieves the advantage that the guide part and the frame part can easily be joined together by an axial push-fit movement.

Instead of a splined shaft connection, a polygonal connection or a notched toothing are conceivable, and other connections which transmit torque.

According to one exemplary arrangement, the actuator assembly comprises a brake caliper, and the guide part is a bearing sleeve which is received in the brake caliper.

This means that the guide part can be produced separately from the brake caliper, so a different material can be selected for the guide part than for the brake caliper, for example a material with particularly good slide properties. Thus a machining of the running face may be omitted.

According to an alternative exemplary arrangement, the actuator assembly comprises a brake caliper, and the guide part is a sleeve-like portion of the brake caliper. This means that the sleeve-like portion is formed integrally with the brake caliper. In comparison with a two-piece design with separate bearing sleeve, this achieves the advantage that fewer components are required and assembly is thereby simplified.

A space for a brake disc is for example present in the brake caliper, wherein the guide part is open towards the space so that the actuating slide can be moved into the space. Thus the brake pad arranged in the space can be moved by the actuating slide.

In one exemplary arrangement, the actuating slide can be moved between a retracted position and an extended position.

A fixing interface for an electric motor may be formed on the frame part.

Thus there is no need for a separate bracket for the electric motor, and the actuator assembly can be designed compactly.

Furthermore, a receiving space for a gear unit may be formed on the frame part. This further contributes to a compact design of the actuator assembly.

The frame part may accordingly receive the electric motor and gear mechanism and absorb their forces.

The actuator assembly comprises a gear unit driving a spindle drive on which the actuating slide is mounted, such that a rotation of the spindle drive causes an axial displacement of the actuating slide. Such an arrangement allows for a rotational motion to be translated into a linear motion in a simple fashion.

For example, the electric motor is coupled for drive purposes to the actuating slide via the gear unit and spindle drive in order to move the actuating slide between the retracted position and the extended position. The actuator assembly is accordingly an electromechanical actuator assembly. An electric motor allows for a sufficiently high force to be generated to apply a brake pad to a brake disc by the actuating slide.

In one exemplary arrangement, the actuating slide is guided rotationally fixedly in the guide part by a rotational locking element. This contributes to a particularly stable guidance of the actuating slide. Because a rotation of the actuating slide is prevented, it is guaranteed that a rotational movement of the spindle drive is completely translated into a linear movement of the actuating slide.

The disclosure furthermore concerns an electromechanical brake with an actuator assembly according to the disclosure and a brake disc which can be decelerated thereby.

### BRIEF DESCRIPTION OF DRAWINGS

Further advantages and features of the disclosure will become apparent from the following description and from the accompanying drawings, to which reference is made. In the drawings:

FIG. 1 shows, in a sectional illustration, an electromechanical brake according to the disclosure with an actuator assembly according to the invention in a first exemplary arrangement,

FIG. 2 shows a drive assembly of the actuator assembly according to the disclosure from FIG. 1,

FIG. 3 shows, in an exploded perspective view, a carrier assembly of the drive assembly from FIG. 2, and

FIG. 4 shows, in a sectional illustration, an actuator assembly according to the disclosure in a further exemplary arrangement.

### DETAILED DESCRIPTION

FIG. 1 shows an actuator assembly 10 as part of an electromechanical vehicle brake.

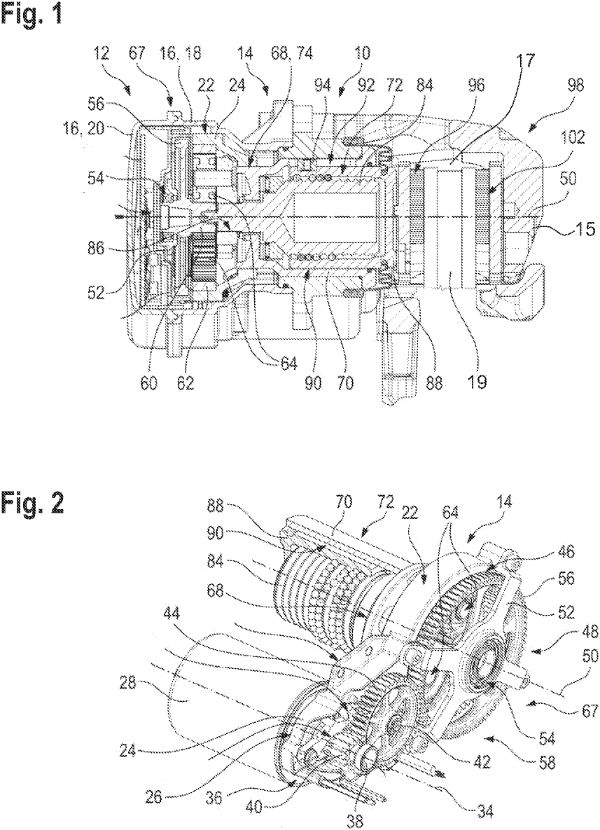

The actuator assembly 10 comprises a control assembly 12, mountable as a separate sub-unit, and a drive assembly 14, also mountable as a separate sub-unit (see FIG. 2).

The control assembly 12 and the drive assembly 14 are arranged in a common housing 16.

The housing 16 comprises a substantially sleeve-like housing base part 18 and a housing cover 20, by which the housing base part 18 can be tightly closed in fitted state.

In the exemplary arrangement shown, the housing cover 20 is substantially dish-shaped.

Both the housing base part 18 and the housing cover 20 are made of a plastic material. Thus the housing 16 as a whole is made of plastic material.

Furthermore, the actuator assembly 10 comprises a brake caliper 15 in which a space 17 for a brake disc 19 is formed. The end of the housing 16 closest to the brake disc 19 is pushed partially onto the brake caliper 15.

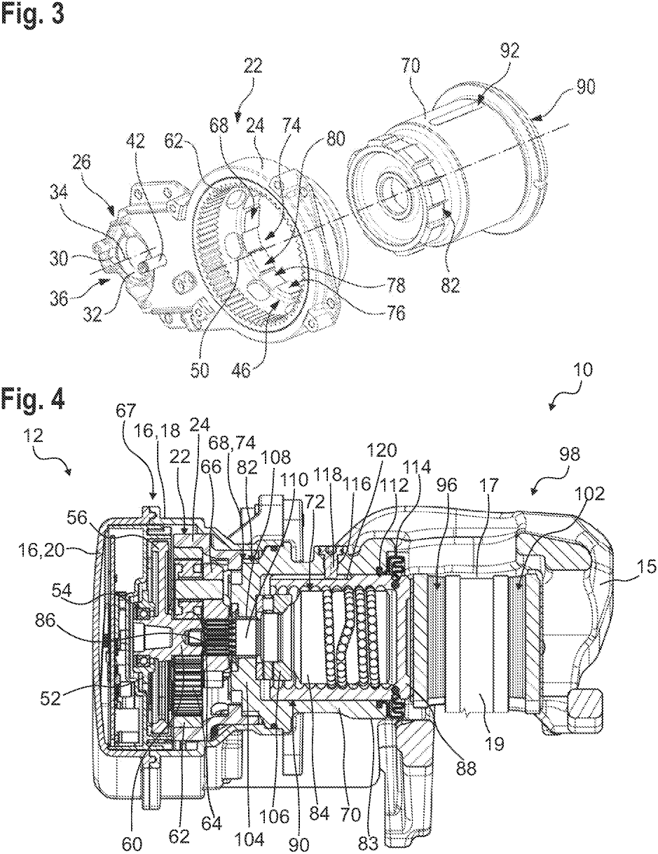

The drive assembly 14 comprises a carrier assembly 22 which has a plate-like frame part 24, as FIGS. 2 and 3 show clearly.

A first fixing interface 26 is provided on the plate-like frame part 24, at which, in the exemplary arrangement illustrated, an electric motor 28 is attached.

More precisely, the electric motor 28 is captively connected to the frame part 24 via the first fixing interface 26. For this, a bore 30 (see FIG. 3) is provided on the frame part 24, via which the electric motor 28 may be attached to the frame part 24 by a fastener, such as a screw. The frame part 24 absorbs the forces of the electric motor 28 and retains this.

In addition, a centring device 32 (see FIG. 3 again) in the form of a centring face is arranged on the frame part 24. The electric motor 28 may thus be attached to the frame part 24 so as to be centred with respect to a centre axis 34 of the first fixing interface 26.

Also, a rotational locking device 36 is provided in the form of a rotational locking depression, which is configured to prevent the electric motor 28 from rotating relative to the frame part 24.

An output gear wheel 40 is arranged on an output shaft 38 of the electric motor 28 for the introduction of torque into the drive assembly 14, as shown in FIG. 2.

In addition, a bearing journal 42 is provided on the frame part 24, on which, in the exemplary arrangement illustrated, a gear wheel 44 is mounted which meshes with the output gear wheel 40.

Also on the frame part 24, a receiving space 46 is provided for a planetary gear stage 48.

A centre axis 50 of the receiving space 46 is arranged substantially parallel to the centre axis 34 of the first fixing interface 26.

Furthermore, a reinforcement part 52 is attached to the frame part 24 such that it spans the receiving space 46 axially at the end relative to the centre axis 50.

In the exemplary arrangement shown, the reinforcing part 52 is substantially cruciform.

Also, a bearing point 54 is provided on the reinforcing part 52 for a gear wheel 56, which is arranged coaxially to the planetary gear stage 48.

The gear wheel 56 meshes with the gear wheel 44.

Accordingly, the gear wheel 44 and the gear wheel 56 form a wheel gear mechanism 58, for which the output gear wheel 40 acts as the input member.

Furthermore, the gear wheel 56 is formed integrally with a sun gear 60 (see FIG. 1) of the planetary gear stage 48. In this way, the wheel gear mechanism 58 and the planetary gear stage 48 are coupled together for drive purposes.

The planetary gear stage 48 also comprises a ring gear 62 which runs substantially around an inner circumference of the receiving space 46 (see FIG. 3).

For drive purposes, in the exemplary arrangement illustrated, a total of three planet gears 64 are provided between the sun gear 60 and the ring gear 62, as FIG. 2 shows clearly. These planet gears are mounted rotatably on a planet carrier 66.

The planet carrier 66 forms an output element of the planetary gear stage 48.

The wheel gear mechanism 58 and the planetary gear stage 48 are jointly known as the gear unit 67.

The frame part 24 additionally comprises a second fixing interface 68, which is configured for fixing of a guide part 70 for a spindle drive 72.

In the exemplary arrangement shown in FIGS. 1 to 3, the guide part 70 is a bearing sleeve which is received in the brake caliper 15. For example, the bearing sleeve is pressed into the brake caliper or welded thereto.

A centre axis of the second fixing interface 68 is here congruent with the centre axis 50 of the receiving space 46 and for this reason carries the same reference sign.

The second fixing interface 68 has a rotational locking geometry 74 which runs circumferentially around the centre axis 50 and is formed by several radial protrusions 76 and radial depressions 78 arranged alternately around the circumference. The rotational locking geometry 74 is thus a shaft-hub connection, in this exemplary arrangement a splined shaft geometry. For reasons of greater clarity, in FIG. 3 only one exemplary radial protrusion 76 and one exemplary radial depression 78 carry a reference sign.

The radial protrusions 76 and the radial depressions 78 have a constant pitch. This means that the radial depressions 78 are each the same length in the circumferential direction. The radial protrusions 76 are also each the same length in the circumferential direction. In addition, a radial height of the radial protrusions 76 is constant.

In this way, a rotational locking device 80 of the second fixing interface 68 is formed.

A complementary rotational locking geometry 82 is provided on the end of the guide part 70 to be coupled to the second fixing interface 68, so that the guide part 70 can be inserted along the centre axis 50 into the rotational locking geometry 74 of the second fixing interface 68 and be held there rotationally fixedly by form fit. The rotational locking geometry is also a splined shaft geometry.

A spindle drive 72 is received in the interior of the guide part 70.

This comprises a spindle 84, in the present case configured as a recirculating ball spindle (see in particular FIGS. 1 and 2).

The spindle 84 is rotationally fixedly connected to the planet carrier 66 via a toothing portion 86.

Thus the spindle drive 72 can be driven by means of the electric motor 28. In detail, the electric motor 28 is coupled to the spindle drive 72 for drive purposes via the wheel gear mechanism 58 and the planetary gear stage 48.

An actuating slide 88 is mounted on the spindle 84 and configured as a piston-like spindle nut.

Rotation of the spindle 84 causes an axial displacement of the actuating slide 88 along the centre axis 50.

The actuating slide 88 is here guided along the centre axis 50 on a running face 90, wherein the running face 90 is formed on an inside of the guide part 70. The running face 90 substantially corresponds to a cylinder casing surface forming the inner circumference of the guide part 70. In other words, the actuating slide 88 is mounted in the guide part so as to be linearly displaceable.

Furthermore, the actuating slide 88 is prevented from relative twisting about the centre axis 50 by means of a rotational locking device 92 which is formed as a slot on the guide part 70. For this, a rotational locking element 94 which engages in the slot is arranged on the actuating slide 88 (see FIG. 1). The rotational locking element 94 in this exemplary arrangement is a radial protrusion.

The actuating slide 88 serves for applying a first brake pad 96 of a brake jaw assembly 98 to the brake disc 19. In other words, due to the actuator assembly 10, the first brake pad 96 can be actively moved towards a brake disc 19, formed as a disc in the exemplary arrangement illustrated.

In detail, due to the electric motor 28, the actuating slide 88 is transferred optionally, via the wheel gear mechanism 58, the planetary gear stage 48 and the spindle drive 72, into an extended position assigned to application of the first brake pad 96 on the brake disc 19.

Because of the reaction forces acting inside the actuator assembly 10 and the brake jaw assembly 98, a second brake pad 102 is thereby also applied to the brake disc 19.

It is clear that the actuating slide 88 can be moved in the same way, by operation of the electric motor 28, into a retracted position which is assigned to a lifting of the first brake pad 96 and the second brake pad 102 from the brake disc 19.

In the present exemplary arrangement, the actuator assembly 10 is designed without self-inhibition so that, because of system-inherent elasticities, the actuating slide 88 also automatically moves back into the retracted position when no longer actively loaded into the extended position by the electric motor 28.

FIG. 4 shows an actuator assembly 10 according to a further exemplary arrangement.

In the description below, the same reference signs are used for identical structures with the same functions as known from the above exemplary arrangement, and to this extent reference is made to the preceding explanations, wherein only the differences between the respective exemplary arrangements will be discussed below so as to avoid repetition.

The actuator assembly 10 according to FIG. 4 differs from the actuator assembly 10 according to FIGS. 1 to 3 in that the guide part 70 is not formed as a separate bearing sleeve but is formed integrally in the brake caliper 15.

More precisely, the guide part 70 is formed by a sleeve-like portion of the brake caliper 15.

Accordingly, the rotational locking geometry 82 is formed on the brake caliper 15, namely on an outer wall 83 of the brake caliper in the region of the sleeve-like portion 70.

In addition, the rotational locking device 92 is also different.

An opening 116 is provided in the brake caliper 15 in the region of the guide part 70. A rotational locking element 118 is inserted in the opening 116 and protrudes through the opening 116 to engage in an axially running groove 120 on the actuating slide 88.

In the exemplary arrangement shown, the rotational locking element 118 is a screw which is screwed into a threaded bore forming the opening 116.

Further exemplary arrangements have the common feature that the guide part 70 is open towards the space 17 so that the actuating slide 88 can be moved into the space 17.

1. An actuator assembly for an electromechanical vehicle brake, comprising:
a carrier assembly having a frame part, and a guide part in which an actuating slide for a brake pad is mounted so as to be linearly displaceable,
wherein the guide part has a rotational locking geometry by which the guide part is rotationally fixedly received in the frame part by form fit.

2. The actuator assembly according to claim 1, wherein the form-fit, rotationally fixed connection is a shaft-hub connection.

3. The actuator assembly according to claim 1, wherein the actuator assembly comprises a brake caliper and the guide part is a bearing sleeve which is received in the brake caliper.

4. The actuator assembly according to claim 1, wherein the actuator assembly comprises a brake caliper, and the guide part is a sleeve-like portion of the brake caliper.

5. The actuator assembly according to claim 3, wherein a space for a brake disc is present in the brake caliper, wherein the guide part is open towards the space so that the actuating slide can be moved into the space.

6. The actuator assembly according to claim 1, wherein fixing interface for an electric motor is formed on the frame part.

7. The actuator assembly according to claim 1, wherein a receiving space for a gear unit is formed on the frame part.

8. The actuator assembly according to claim 1, wherein the actuator assembly comprises a gear unit driving a spindle drive on which the actuating slide is mounted, such that a rotation of the spindle drive causes an axial displacement of the actuating slide.

9. The actuator assembly according to claim 1, wherein the actuating slide is guided rotationally fixedly in the guide part by a rotational locking element.

10. An electromechanical vehicle brake with an actuator assembly according to claim 1 and a brake disc which the actuator assembly can contact.

11. The actuator assembly according to claim 2, wherein the shaft-hub connection is a splined shaft connection.

12. The actuator assembly according to claim 2, wherein the actuator assembly comprises a brake caliper, and the guide part is a sleeve-like portion of the brake caliper.

13. The actuator assembly according to claim 2, wherein the actuator assembly comprises a brake caliper, and the guide part is a bearing sleeve which is received in the brake caliper.

14. The actuator assembly according to claim 4, wherein a space for a brake disc is present in the brake caliper, wherein the guide part is open towards the space so that the actuating slide can be moved into the space.

15. The actuator assembly according to claim 3, wherein a fixing interface for an electric motor is formed on the frame part.

16. The actuator assembly according to claim 4, wherein a fixing interface for an electric motor is formed on the frame part.

17. The actuator assembly according to claim 3, wherein the actuator assembly comprises a gear unit driving a spindle drive on which the actuating slide is mounted, such that a rotation of the spindle drive causes an axial displacement of the actuating slide.

18. The actuator assembly according to claim 4, wherein the actuator assembly comprises a gear unit driving a spindle drive on which the actuating slide is mounted, such that a rotation of the spindle drive causes an axial displacement of the actuating slide.

19. The actuator assembly according to claim 3, wherein the actuating slide is guided rotationally fixedly in the guide part by a rotational locking element.

20. The actuator assembly according to claim 4, wherein the actuating slide is guided rotationally fixedly in the guide part by a rotational locking element.
